(19) United States
(12) Patent Application Publication
(10) Pub. No.: US 2024/0427307 A1
(43) Pub. Date: Dec. 26, 2024

(54) TOOL MONITORING SYSTEM AND METHOD OF USE THEREOF

(71) Applicant: Leidos Industrial Engineering Limited, Wickford (GB)

(72) Inventors: William Watt, Kempston (GB); Andrew Spalding, Sidcup (GB)

(21) Appl. No.: 18/828,409

(22) Filed: Sep. 9, 2024

Related U.S. Application Data
(63) Continuation of application No. PCT/IB2024/000180, filed on Apr. 3, 2024.
(60) Provisional application No. 63/456,712, filed on Apr. 3, 2023.

(51) Int. Cl. G05B 19/4065

(52) U.S. Cl. CPC G05B 19/4065

(57) ABSTRACT

Provided herein is a tool monitoring system and method of use. The tool monitoring system includes a plurality of panels forming a tunnel having a plurality of cameras disposed therein. The plurality of cameras take measurements of a tooling fixture, the tooling fixture having fixtures and features of interest thereon, as the tooling fixture moves in the tunnel. The system calculates a frame of reference of the tooling fixture and compares the actual position of one or more of the features of interest with the apparent position of the one or more features of interest in the frame of reference to determine an offset between the actual and apparent position of the of the one or more features of interest. The system then calculates a function to correct for the offset.

### CROSS-REFERENCE TO RELATED APPLICATION

This application is a continuation of PCT/IB2024/000180, filed on Apr. 3, 2024, which claims the benefit of U.S. Provisional Application No. 63/456,712, filed on Apr. 3, 2023, the contents of each of which are hereby incorporated by reference in their entirety.

### BACKGROUND

Flexible and complex production equipment includes multiple fixtures which have sub-millimeter target tolerances. Incorrect configuration or misalignment of these fixtures causes production stoppages and delays. Further, damaged or misaligned fixtures can cause damage to the manufactured product. Examples can be identified in the automotive industry.

For example, in the electric vehicle (EV) sector of the industry electric vehicle batteries are often heavy, weighing around 450 kg (1000 lbs.), with some weighing as much as 900 kg (2000 lbs.), making them difficult to remove from a fixture if a problem exists, e.g., damage or misalignment of the fixture.

### SUMMARY

According to some embodiments of the present disclosure, a tool monitoring system including a housing is provided. The housing is sized and dimensioned to accommodate a tooling fixture in an interior portion of the housing. The housing having at least one end that is open or openable for ingress and egress of the tooling fixture. The tooling monitoring system also includes a plurality of cameras disposed on interior portions of the walls of the housing. At least three of the plurality of cameras are positioned on the interior portions of the plurality of walls to image a position of an edge portion of at least two sides of the tooling fixture. At least one of the plurality of cameras is positioned on the interior portions of the plurality of walls to image a position of each of a plurality of reference datum on the tooling fixture. At least two of the plurality of cameras are positioned on the interior portions of the plurality of walls to image a position of each of a plurality of features of interest on the tooling fixture.

The tooling monitoring system also includes a computational device having a memory and a processor configured to or programed to execute instructions held in memory to process image data received from each of the plurality of cameras. The processor of the computational device is used to determine a relative location of one or more of the features of interest on the tooling fixture relative to a base of the tooling fixture. The processor also calculates a frame of reference of the tooling fixture based on the position of the edge portions of the at least two sides of the tooling fixture and the position of each of the plurality of reference datum when the tooling fixture is in a first position relative to the housing and as the tooling fixture moves in at least one direction relative to the housing. The processor also calculates one or more correction functions which correct for differences between the position of at least a first of the features of interest and an apparent position of the first of the features of interest in the frame of reference.

According to some embodiments of the present disclosure, a method of operation of a tool monitoring system is provided. The method can begin by imaging a position of an edge portion of a tooling fixture and a position of one or more reference datum disposed on or in the tooling fixture while the tooling fixture is in a central position. The tooling fixture is then moved in at least one direction and the position of the edge portions of the tooling fixture and the position of the one or more reference datum are imaged as the tooling fixture moves. The tool monitoring system can then calculate a frame of reference of the tooling fixture from the positions of the edge portions of the tooling fixture and the one or more reference datum. A position of a feature of interest disposed on the tooling fixture is then imaged as the tooling fixture moves. The tool monitoring system then compares the position of the feature of interest to an apparent position of the feature of interest in the frame of reference to determine an offset of the feature of interest and one or more correction functions which correct for the offset of the feature of interest are calculated.

### BRIEF DESCRIPTION OF DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which like reference numerals refer to like elements throughout the different views:

FIG. 1 is a perspective view of a tool monitoring system and a tooling fixture according to some embodiments of the present disclosure;

FIG. 2 is a perspective view of the tool monitoring system of FIG. 1 without a housing according to some embodiments of the present disclosure;

FIG. 3A is a perspective view of a camera measuring a reference datum according to some embodiments of the present disclosure;

FIG. 3B is the view of the camera from FIG. 3A;

FIG. 4A is a perspective view of a camera measuring a tooling fixture edge according to some embodiments of the present disclosure;

FIG. 4B is the view of the camera from FIG. 4A;

FIG. 5A is a perspective view of a camera measuring a location pin according to some embodiments of the present disclosure;

FIG. 5B is the view of the camera from FIG. 5A;

FIG. 6 is a top down illustration of a tooling fixture and measurement cameras according to some embodiments of the present disclosure;

FIG. 7A is a schematic drawing of a tool monitoring system according to some embodiments of the present disclosure;

FIG. 7B is a block diagram of a computational device for use with a tool monitoring system according to some embodiments of the present disclosure;

FIG. 8 is a perspective view of a tool monitoring system according to some embodiments of the present disclosure;

FIG. 9 is a flow chart of a method for calibrating a tooling fixture according to some embodiments of the present disclosure;

FIG. 10 is a top down illustration of a tooling fixture with reference datum and location pins according to some embodiments of the present disclosure;

FIG. 11 is an exemplary graphical user interface to access a software application for the use and management of a tool monitoring system according to some embodiments of the present disclosure;

FIGS. 12A-12B are exemplary graphical user interface for configuring cameras for use with a tool monitoring system according to some embodiments of the present disclosure;

FIG. 13 is an exemplary graphical user interface for viewing current and past measurement data of a tool monitoring system according to some embodiments of the present disclosure;

FIG. 14 is an exemplary graphical user interface for displaying camera and diagnostic images of a tool monitoring system according to some embodiments of the present disclosure.

### DETAILED DESCRIPTION

The subject matter disclosed herein relates to systems and methods for monitoring fixtures, e.g., a tooling fixture. More specifically, the present disclosure relates to a multi-camera monitoring system, which is used to calibrate a tooling fixture by measuring the position of reference features and features of interest on the tooling fixture and calculating a function to be used as a corrective factor for any misalignment of the features of interest within a threshold tolerance.

In some existing tool monitoring systems, the position of the features of interest are measured using 2D (area scan) cameras. The use of these cameras can require the distortion of the lens/camera compensation to be rectified, and a scale factor (pixels-per-mm) to be determined for movements in the measurement plane (i.e., the plane within the field of view of the camera of which the camera has been calibrated to measure). This can be carried out using reference patterns (such as a chessboard or array of circles of known dimensions) fixed temporarily in the measurement plane. Multiple measurements are used to determine the tooling fixture location, and for each required measurement point (e.g. feature of interest), two or more cameras are used in a stereo arrangement to determine the 3D location.

When calibrating a tooling fixture, there is often a tolerance stack associated with the 2D camera to be considered which includes: intrinsic calibration properties of the camera used for measuring the position of the tooling fixture and features of interest, e.g., the lens/view type; extrinsic calibration properties of the camera, e.g., distance to the object being measured and orientation with respect to the tooling fixture; the target manufacturing tolerance; image acquisition noise, e.g., focus, lighting, and sensor noise; lighting effects, e.g., intensity and shadowing change as the tooling fixture moves; pixels-per-mm manufacturing tolerance of a printed reference object used to calibrate the cameras; location of features of the reference pattern in the image processing software, for example, the position of a feature is identified by an image processing algorithm and this image processing is subject to some tolerance; inaccuracies in the placement of the reference pattern in the measurement plane during calibration; movement of the feature of interest, or other feature to be measured, out of the measurement plane when measuring; and parallax effects in the image when the feature of interest or other feature to be measured, moves within the measurement plane.

Any inaccuracy in the scaling factors established by the aforementioned tolerance stack will have an effect on the measured position of the tooling fixture. When calibrating the tooling fixture, the target tolerance of the tooling fixture is the difference between the offset of the feature of interest, e.g., a location pin, and the offset of the tooling fixture. If the calibration factors of the cameras which take these two measurements are different (especially if they have changed in opposite directions) this can become significant.

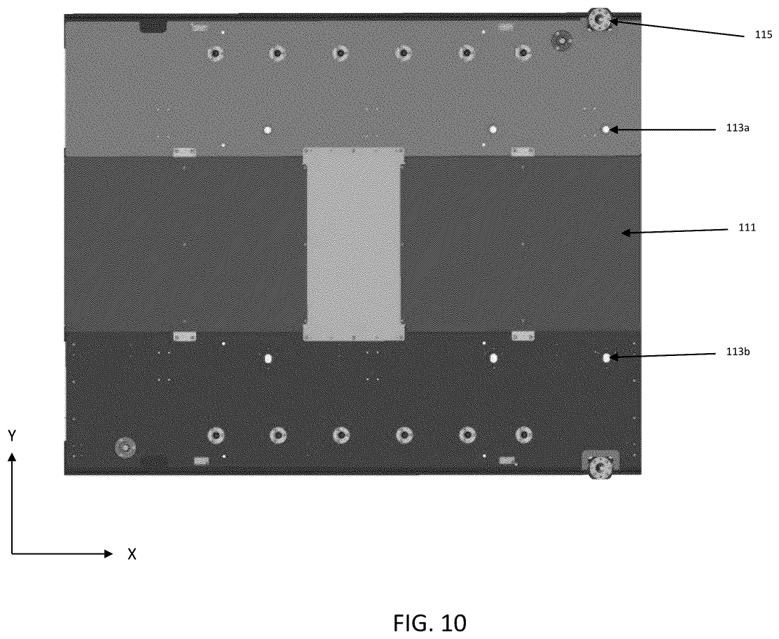

For example, with reference to FIG. 10, assuming a tooling fixture 111 moves 10 mm in the +X direction, and the stack of tolerances of the cameras measuring the reference features, e.g., a first reference datum 113a and a second reference datum 113b, on the tooling fixture 111 are the same and scale the apparent movement of the tooling fixture by 105%, the apparent movement of the tooling fixture 111 would be 10.5 mm in the +X direction. If simultaneously the stack of tolerances of camera measuring the feature of interest, e.g., a location pin 115, is scaled by 95%, the apparent movement of the first location pin 115 would be 9.5 mm. In relation to the reference frame of the tooling fixture 111, an ideally-positioned location pin would therefore have an apparent offset of 1 mm. By way of further example, in the same situation where the tooling fixture 111 moves 10 mm in the +X direction, but the stack of tolerances of the camera measuring the first reference datum 113a and the stack of tolerance of the camera measuring the second reference datum 113b are different, then the rotation free movement of 10 mm in the +X direction would result in an apparent twisting of the tooling fixture, which can result in a greater apparent offset of the location pin 115.

In some embodiments of the present disclosure, a multi-camera calibration system which is used to detect misaligned pins on a tooling fixture and correct for the misalignment is provided. The tooling fixture can be brought to the multi-camera calibration system on a conveyor, and stop within +\−10 mm in the direction of travel, e.g., the X direction, with some variation in the Y and Z direction, in addition to some small rotations about all three axes. In some embodiments, the variation in the Y and Z axis may be +\−3 mm and the rotation about all three axes may be +\−3 seconds of arc. The initial position of the tooling fixture is defined as the nominal, central position, the tooling fixture is then moved between a number of positions within the tooling fixture's movement range, e.g., +\−10 mm in the X direction, +\−3 mm in the Y and Z direction and +\−3 seconds of arc in the rX, rY, and rZ directions. In some embodiments, the tooling fixtures movement range may be +/−5 seconds of arc in the rX, rY, and rZ directions. The position and orientation of the tooling fixture can be measured using features thereon, e.g., a reference datum, and the edges of the tooling fixture, and the position of the features of interest, e.g., location pins, on the tooling bed can also be measured at each position. A frame of reference of the tooling fixture can be calculated from the measurements of the reference datum and the edges of the tooling fixture and the measured position of the pin is compared to the apparent position of the pin in the reference frame of the tooling fixture to obtain an offset in the pin position. Any offset in the pin position within the frame of reference of the tooling fixture indicates misalignment of the pin. A function which predicts the apparent movement of the location pin in the frame of reference of the tooling fixture can then be calculated. The function can be used as a correction factor to account for the apparent offset in the pin position during manufacturing to account for the tolerance stack during calibration.

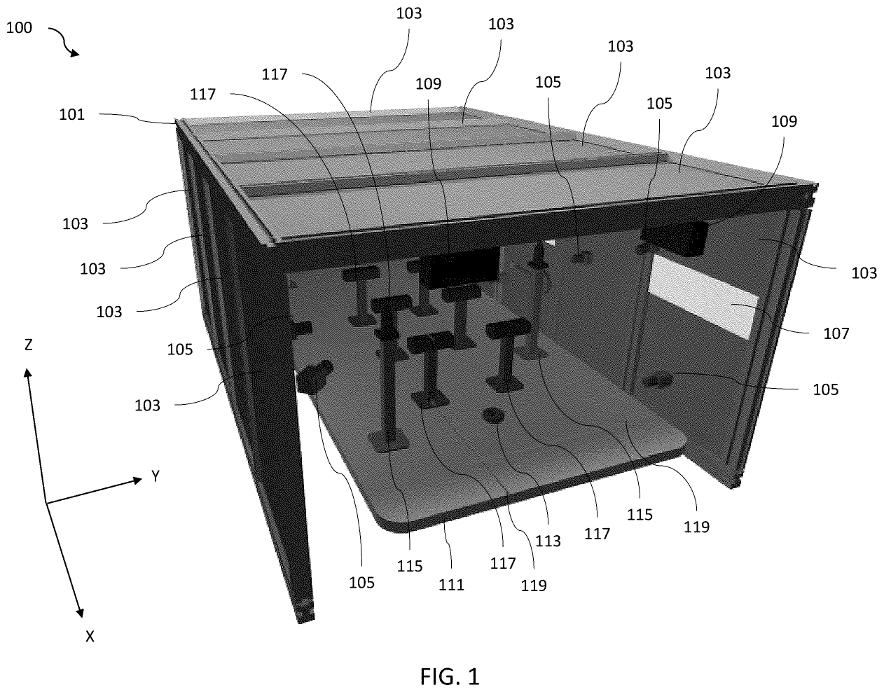

Referring now to FIG. 1, shown is a tool monitoring system 100 according to some embodiments of the present disclosure. The tool monitoring system 100 may include a housing 101 which may be made up of a plurality of panels 103. The tool monitoring system 100 can include measurement tools such as a plurality of cameras 105 to take precise measurements and a plurality of laser profilers 109 to inspect large features, the cameras 105 and the laser profiler 109 may be housed in the interior of the housing 101. While the tool monitoring system 100 is depicted as having both cameras 105 and laser profilers 109, it is understood that the tool monitoring system 100 may include either the cameras 105 or the laser profilers 109 or both to take measurements. In some embodiments the laser profilers 109 may be replaced by additional cameras 105. The housing 101 may also include lights 107 on the interior walls and/or ceiling of the housing 101 to illuminate parts therein and in some embodiments serve as an illuminated backdrop to increase the accuracy of the measurements taken. The number and configuration of the cameras 105, the lights 107, and the laser profilers 109 varies depending on the desired use case, e.g., a number of features to be measured, a desired measurement redundancy, and measurement accuracy, although not limited thereto.

The housing 101 can be sized accommodate the tooling fixture 111 therein. The housing 101 can include at least one end that is open or openable for ingress and egress of the tooling fixture 111. The tool monitoring system 100 and the housing 101 can be fixed in place with the tooling fixture 111 moving in at least one direction relative to the housing 101. The initial position of the tooling fixture 111 in the housing 101 is defined as the nominal, central position. In some embodiments, the tooling fixture 111 can move in six degrees of freedom, for example, the X, Y, Z and rX, rY, rZ directions. The tooling fixture 111 can have a plurality of reference datum 113 and a plurality of features of interest arranged on the tooling fixture. The plurality of features of interest can include a plurality of location pins 115 and a plurality of pads 117. While a plurality of location pins 115 and a plurality of pads 117 are used to define the features of interest, other fixtures or features on the tooling fixture 111 may be a feature of interest depending on a desired use case. For the purpose of explanation of the invention a hole may be used as the reference datum 113; however the plurality reference datum 113 may a retroreflective target, an LED, bush, or another feature/fixture which can be identified and measured by the plurality of cameras 105.

In some embodiments, the plurality of pads 117 are used to support an object placed on the tooling fixture 111. In some embodiments, the plurality of location pins 115 can support an object placed on the tooling fixture 111 either alone or in combination with the plurality of pads 117.

The plurality of cameras 105 may be used to take precise measurements of the location of each of the reference datum 113, each of the location pins 115, and each of the pads 117 and may have sub-millimeter accuracy. In some embodiments, the plurality of cameras 105 may take measurements with +/−1.0 mm accuracy, +/−0.5 mm accuracy, +/−0.25 mm accuracy, or +/−0.2 mm accuracy depending on desired tolerances, although not limited thereto. In some embodiments, the measurements taken by the plurality of cameras 105 may be compared to reference tooling which has been coordinate measurement machine (CMM) checked: e.g., the relative location of two or more of the location pins 115 is triangulated and compared to the relative location of the same two or more location pins 115 on a reference tooling.

In some embodiments, depending on the distance from one or more of the cameras 105 to the feature to be measured, e.g., the tooling fixture 111, one of the plurality of reference datum 113, one of the plurality of location pins 115, or one of the plurality of pads 117, and the requisite tolerance, the focal length of the plurality of cameras 105 may change. A longer focal length lens provides a narrower view angle, but also a higher resolution image at further distances and therefore higher accuracy measurements. In some embodiments, the plurality of cameras 105 may have the same focal length. In some embodiments, the plurality of cameras 105 may have varying focal lengths depending on the distance from the particular camera to the feature being measured. For example, the plurality of cameras 105 mounted on the ceiling of the housing 101 measuring features on the tooling fixture 111 may need to have longer focal length lens than cameras 105 mounted on the side walls of the housing 101 measuring the edge of the tooling fixture 111.

Each of the plurality of laser profilers 109 can project a laser line 119 on the tooling fixture 111, which can be used to detect/inspect the tooling fixture 111, the plurality of reference datum 113, the plurality of location pins 115, and the plurality of pads 117. For example, the laser profilers 109 may be used for measurements which do not require sub-millimeter accuracy such as the configuration/presence of the plurality of reference datum 113, the plurality of location pins 115, and the plurality of pads 117 (i.e., whether the features are present and generally oriented in the correct position relative to each other) and wear/damage to the tooling fixture 111, the plurality of reference datum 113, the plurality of location pins 115, and the plurality of pads 117.

In some embodiments, the tool monitoring system 100 may include two laser profilers 109 each projecting a laser line 119 in one of the X and Y direction on to the tooling fixture 111. As the tooling fixture 111 moves in one or more directions, the projected laser line 119 is broken as features, e.g., the plurality of reference datum 113, the plurality of location pins 115, or the plurality of pads 117, pass under the laser line 119, thereby signifying the presence of a feature. The presence of these features may be recorded sequentially in the X and Y direction by the respective laser profiler 109 and compared to a known or expected sequence of features to determine if the tooling fixture 111 is configured correctly. The absence of a feature in the expected sequence or location may indicate one of the plurality of reference datum 113, the plurality of location pins 115, or the plurality of pads 117 is missing from the tooling fixture 111 and the presence of an additional feature may indicate that the tooling fixture 111 is damaged, e.g., a cut or depression on the tooling fixture 111.

In some embodiments, the housing 101 is dimensioned to accommodate the size of the tooling fixture 111 as well as dimensioned so that the measurement devices, the camera 105 and the laser profilers 109, are within a selected focal distance to the part being measured, e.g., reference datum 113, location pins 115, and pads 117 arranged in or on the tooling fixture 111. As discussed herein, the proximity of the plurality of cameras 105 to the feature to be measured may allow for shorter focal length lens.

In some embodiments, the panels 103 may be slidably coupled to each other forming a modular design such that additional panels 103 may be coupled to each other or excess panels 103 may be removed to size the housing 101 to accommodate tooling fixtures 111 of any size and orientation. One or more of the panels 103 may be detached from adjacent panels 103 to provide access to the interior of the housing 101, for example, to replace or adjust one of the cameras 105, lights 107, and laser profilers 109, service the tooling fixture 111, and/or service the tool monitoring system 100, although not limited thereto. In another embodiment, one or more of the panels 103 may be coupled to an adjacent panel 103 by a hinge thereby allowing the hinged panel 103 to swing open to provide access to the interior of the housing 101.

In some embodiments, the panels 103 may be opaque or have varying levels of opacity to block ambient light as desired. Ambient light may reduce the accuracy of or interfere with measurements taken by the cameras 105 or laser profilers 109. The shape and size of the housing 101 as well as the opacity of the panel 103 may provide increased light tolerance.

In some embodiments, the housing 101 may be mounted on anti-vibration machine mounts, e.g., vibration damping mounts or vibration isolation mounts, to provide increased vibration tolerance and mitigate image blur of the plurality of cameras 105. Further, one or more of the plurality of cameras 105 may be mounted on an anti-vibration machine mount, e.g., a vibration damping mount or a vibration isolation mount, instead of or in addition to the housing 101 being mounted on anti-vibration machine mounts. In some embodiments, the tool monitoring system 100 may include thermal resistant materials to provide thermal tolerance and prevent image warping or distortion or both, for example, the plurality of panels 103 may be made of thermal resistant or reflective material which resists external temperature change.

In some embodiments, one or more of the plurality of cameras 105 may take redundant images/measurements as another of the plurality of cameras 105 so that in the event one of the plurality cameras 105 fails or is out of calibration, measurement of the tooling fixture 111 continues and production is not disrupted.

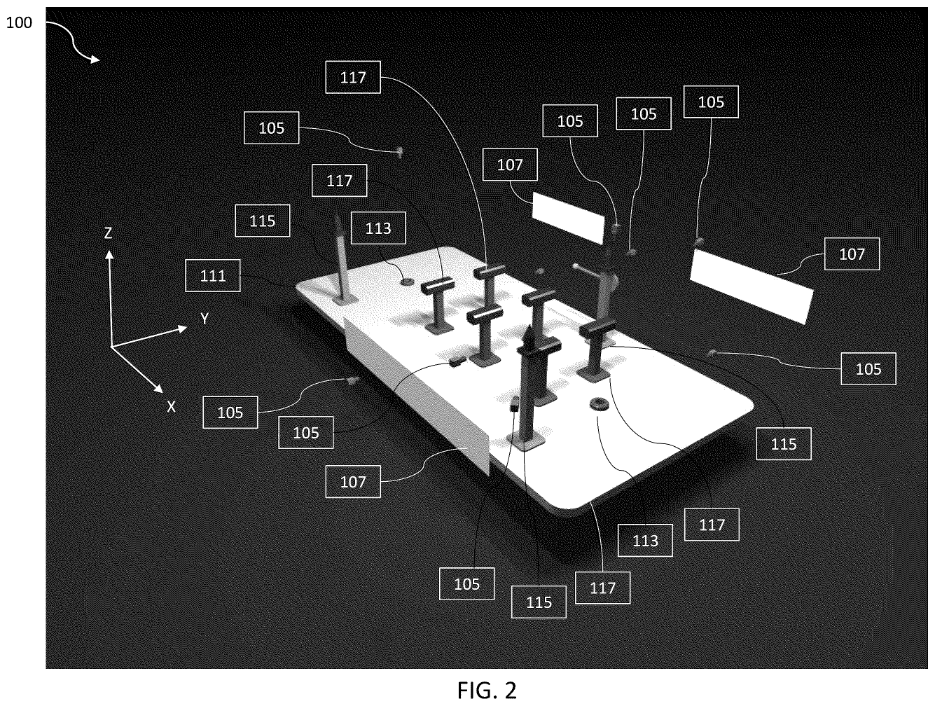

Referring now to FIG. 2., shown is a perspective of the tool monitoring system 100 of FIG. 1 without the housing 101. Some of the plurality of cameras 105, the plurality of lights 107, the plurality of reference datum 113, the plurality of location pins 115, and the plurality of pads 117 which were partially or fully obscured by the housing 101 are shown more clearly. For example, one or more of the plurality of cameras 105 mounted on the ceiling of the housing 101 (not shown in FIG. 1) are shown in FIG. 2. The plurality of cameras 105 mounted on the ceiling may have a longer focal length lens.

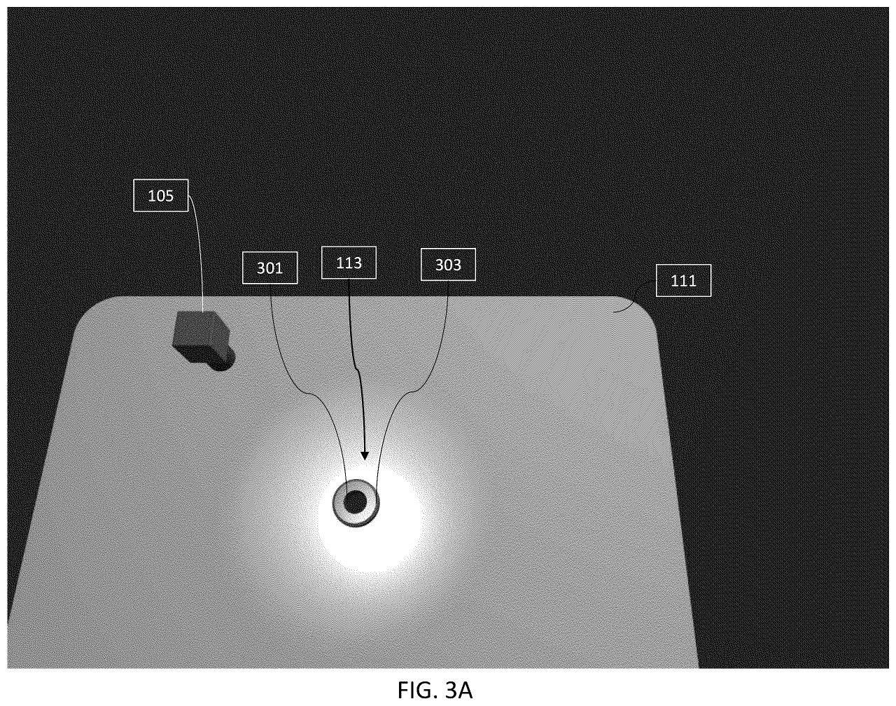

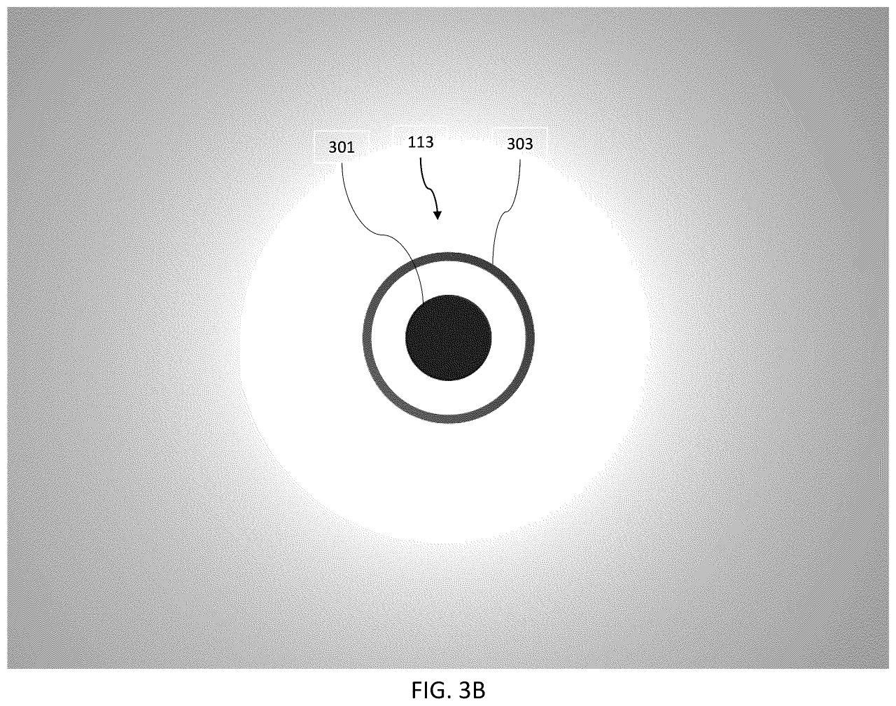

Referring now to FIGS. 3A-3B, shown is one of the plurality of the cameras 105 relative to one of the plurality of reference datum 113 disposed on the tooling fixture 111 according to some embodiments of the present disclosure. A group of the plurality of the cameras 105 may be mounted on the ceiling of the housing 101 and may be directed towards the reference datum 113, measuring the center 301 of the reference datum 113. The tooling fixture 111, and therefore the attached reference datum 113, is moved in each of the degrees of freedom being measured, e.g., X, Y, Z and rX, rY, rZ. As the tooling fixture 111 moves, the camera continues measuring the center 301 of the reference datum 113 to establish a frame of reference of the tooling fixture 111. The X, Y, and rZ movement of the tooling fixture 111 can be calculated from the measured position of the reference datum 113. FIG. 3B shows a closer view of the center 301 of the reference datum 113 from FIG. 3A, the camera 105 sees a dark hole, the center 301 of the reference datum 113, and a dark outer chamfer, the edge 303 of the reference datum 113, which can be used to find the position of the center 301.

In some embodiments, the measured position of two or more reference datum 113 can be used to establish the X, Y, and rZ movement of the tooling fixture 111. The presence of additional reference datum 113 may improve the accuracy of the calculated X, Y, and rZ movement, but also necessitates additional cameras to measure the position of the reference datum 113. In some embodiments, the reference datum 113 may be distributed across the tooling fixture 111 to provide positional measurements at different points of the tooling fixture. For example, the plurality of reference datum 113 may be evenly distributed being an equal distance from adjacent reference datum 113, the plurality of reference datum 113 may be arranged in a pattern near the features of interest to provide positional/movement data near the points of interest, or the plurality of reference datum 113 may be arranged primarily along one of the axes to more particularly identify movement along said axis, although not limited thereto.

In some embodiments, the X, Y, and rZ movement of the tooling fixture 111 is calculated using a linear/least squares regression, triangulation, polynomial regression, or other non-linear regression model based on the position of one or more of the reference datum 113. In some embodiments, a comparison of regression lines is performed using regressions of the X, Y, and rZ movement of the tooling fixture 111 calculated using different groups of the plurality of reference datum 113 to calculate a best fit.

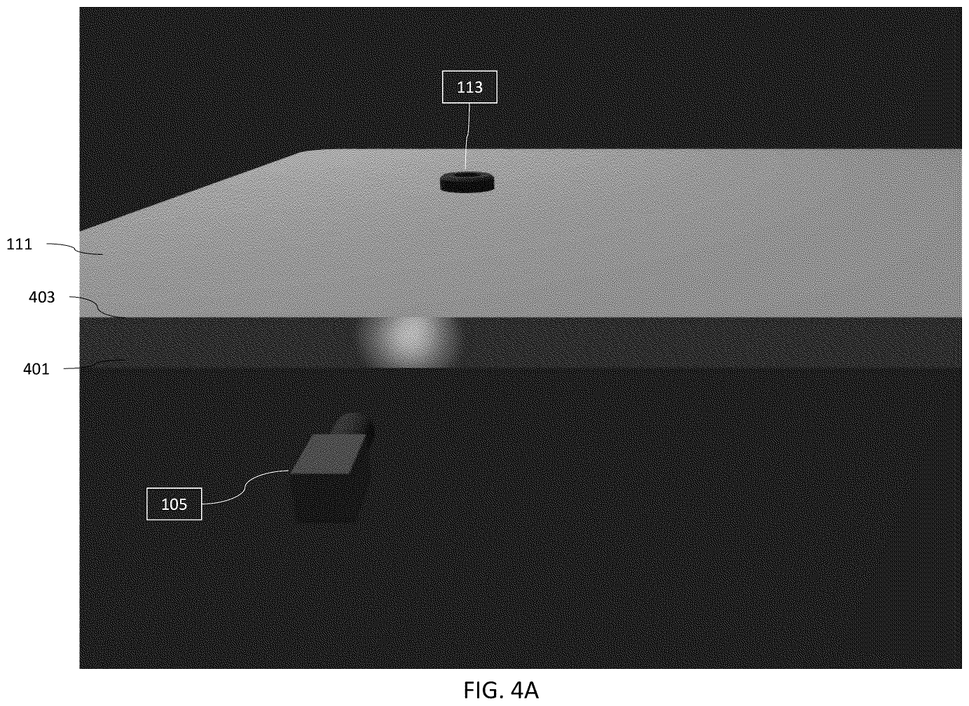

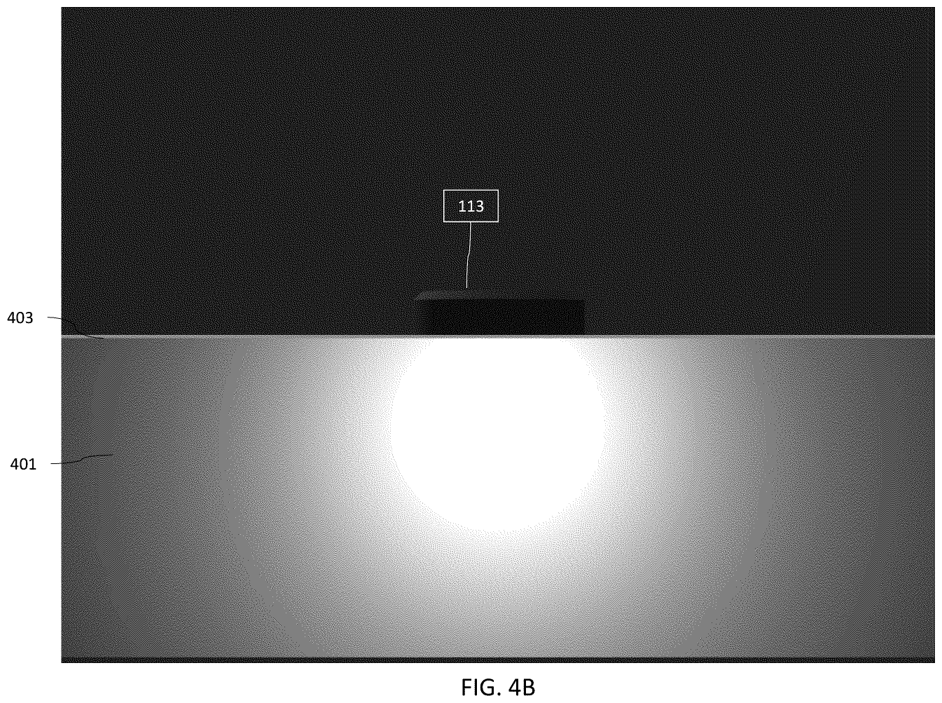

Referring now to FIGS. 4A-4B, shown is one of the plurality of the cameras 105 measuring an edge of the tooling fixture 111 according to some embodiments of the present disclosure. The group of the plurality of the cameras 105 can be directed towards a side 401, for example an edge, of the tooling fixture 111, measuring an edge 403 of the tooling fixture 111 and may be mounted on an interior side wall of the housing 101. In some embodiments, the edge 403 may include one or both of a top edge and a bottom edge of the side 401 of the tooling fixture 111 and the group of the plurality of cameras 105 may measure one or both of the top edge and the bottom edge of the tooling fixture 111. As the tooling fixture 111 moves each of the degrees of freedom, the camera 105 continues to measure the edge 403 of the tooling fixture 111. FIG. 4B shows a closer view of the camera 105 from FIG. 4A, the camera 105 sees the illuminated side 401 of the tooling fixture 111, and a dark background, the edge 403 of the tooling fixture 111. The side 401 can be illuminated by one or more of the plurality of lights 107 mounted separately from the plurality of cameras 105 or may be illuminated by a light affixed to one of the plurality of cameras 105 or both. With at least three cameras 105 distributed around at least two sides 401 of the tooling fixture 111, the Z, rX, and rY movement of the tooling fixture 111 can be calculated from the movement of the edge 403 of the tooling fixture 111. In some embodiments, the movement of the tooling fixture 111 in the Z, rX, and rY directions can be calculated before, after, or simultaneously as the movement of the tooling fixture in the X, Y, and rZ directions as discussed herein.

In some embodiments, increasing the number of the plurality of cameras 105 used to measure the edges 403 of the tooling fixture 111 can provide greater measurement redundancy and provide additional data points used to calculate the Z, rX, and rY movement of the tooling fixture 111.

In some embodiments, the Z, rX, and rY movement of the tooling fixture 111 is calculated using a linear/least squares regression, triangulation, polynomial regression, or other non-linear regression model based on the position of at three or more points around at least two sides 401 of the tooling fixture 111. In some further embodiments, a comparison of regression lines is performed using regressions of the Z, rX, and rY movement of the tooling fixture 111 calculated using different groups of at least three measured points around at least two sides 401 of the tooling fixture 111.

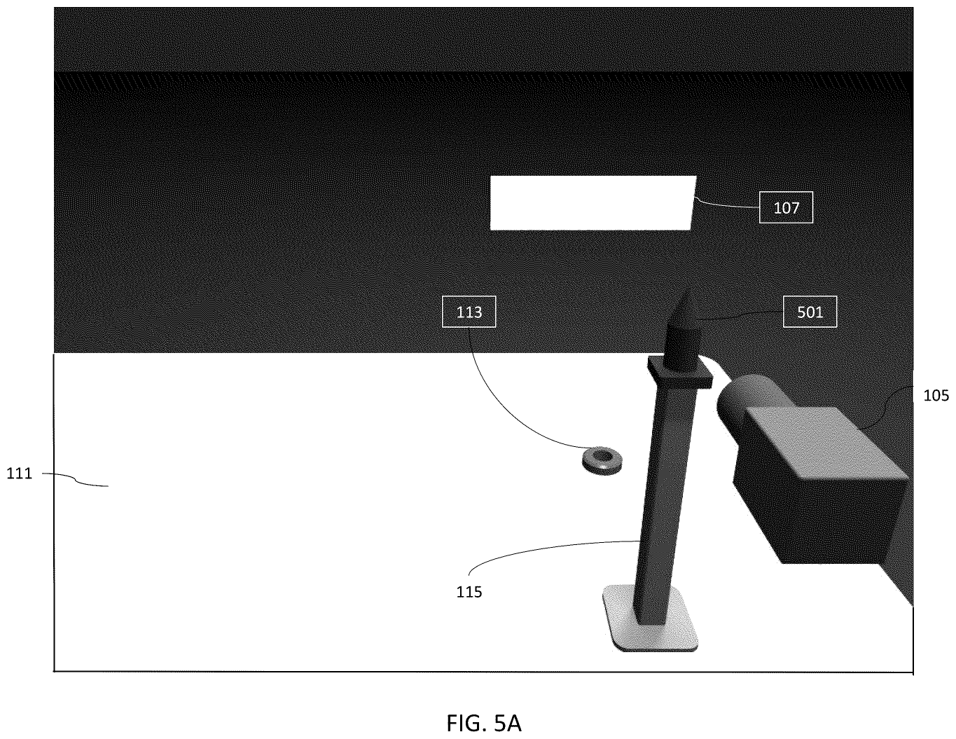

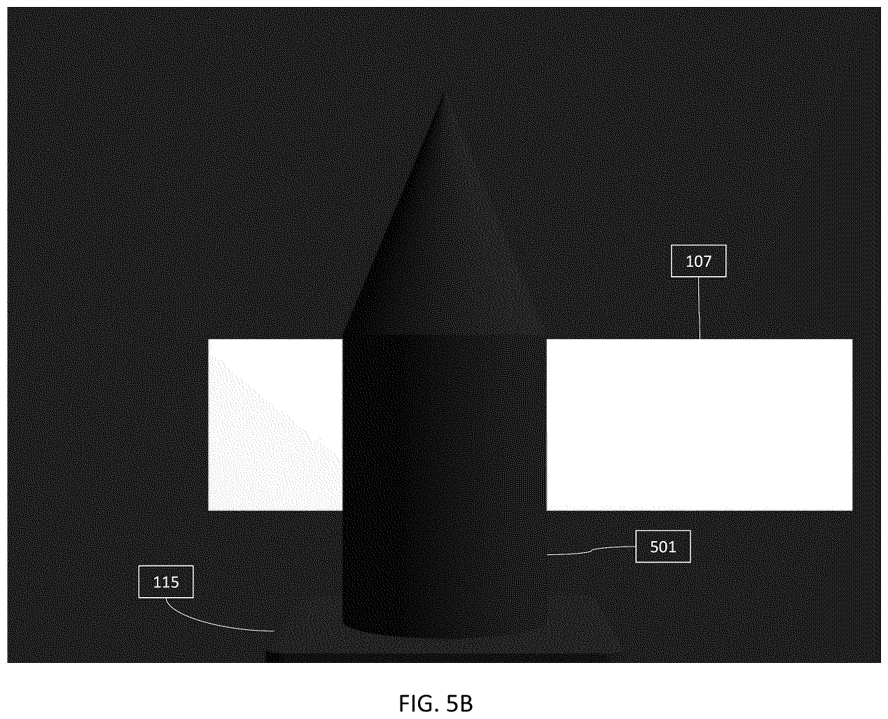

Referring now to FIGS. 5A-5B, shown is one of the plurality of cameras 105 measuring one of the plurality of location pins 115 according to some embodiments of the present disclosure. The group of the plurality of cameras 105 measuring the plurality of location pins 115 may be mounted on an interior side wall of the housing 101 and may be directed towards a tip 501 of the location pin 115, measuring the edge positions of the location pin tip 501. A second camera may be used to measure the edge positions of the location pin tip 501 from an alternate angle/view. The X, Y position of the location pin tip 501, and therefore the location pin 115, is triangulated from the edge position measurements of the location pin tip 501 by the camera 105 and the second camera. The light 107 may be positioned behind the location pin tip 501 in the field of view of the camera 105, serving as an illuminated backdrop to increase accuracy of the edge position measurements of the location pin tip 501. In some embodiments, depending on the angle of the field of view of the camera 105, the same light 107 may be positioned behind the location pin tip 501 of more than one location pin 115. FIG. 5B shows a closer view of the camera 105 from FIG. 5A, the camera 105 sees a high contrast silhouette of the location pin tip 501 against the light 107.

In some embodiments, a threshold tolerance for the allowable manufacturing error, e.g., +/−1.0 mm, +/−0.5 mm, +/−0.25 mm, or +/−0.2 mm, may be set by a user or may be predetermined depending on the intended use of the tooling fixture 111. Critical out of tolerance measurements, for example those that cannot be corrected by applying a function to the features of interest, may trigger a high level alarm to alert the user and may automatically halt the tool monitoring system 100 and/or manufacturing process. Less critical issues, such as damage to the pads 117, may trigger a low level alert notifying a user.

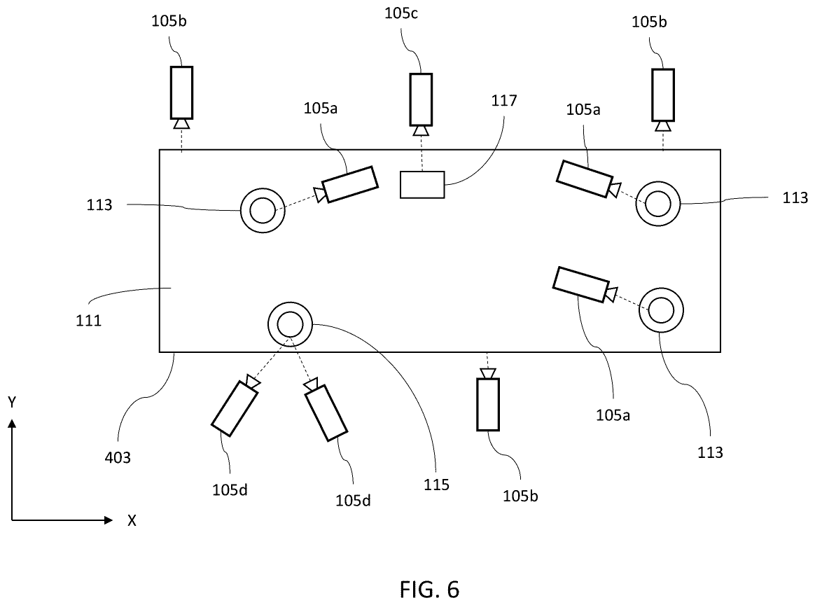

Referring now to FIG. 6 shown is a top down illustration of the tooling fixture 111 and measurement cameras according to some embodiments of the present disclosure. In an exemplary non-limiting embodiment, the tooling fixture 111 may include three reference datum 113, one location pin 115, and one pad 117. The monitoring system may have three downward facing cameras 105a, one for each of the reference datum 113, at least three edge find cameras 105b positioned around at least two edges of the tooling fixture 111, a pad checking camera 105c for each pad 117, and at least two location pin cameras 105d for each location pin 115. In some embodiments, the tool monitoring system 100 may have high tolerances or not be concerned with a shift in the X and Y position of each pad 117 and utilizes one pad checking camera 105c to measure the change in Z position of each pad 117. The downward facing cameras 105a take an initial measurement of the position of the reference datum 113 and the edge find cameras 105b take an initial measurement of the top edge 403 of the tooling fixture 111. As the tooling fixture 111 moves in each of the X, Y, Z and rX, rY, rZ directions the downward facing cameras 105a and the edge find cameras 105b continue to take respective measurements of the reference datum 113 and the edge find cameras 105b take an initial measurement of the top edge 403 of the tooling fixture 111 to establish a frame of reference of the tooling fixture 111 in each of the degrees of freedom X, Y, Z and rX, rY, rZ. A pad checking camera 105c measures the position of the pad 117, and at least two location pin cameras 105d triangulate the position of the location pin 115. The apparent positions of the location pin 115 and the pad 117 in the frame of reference of the tooling fixture 111 are compared to the actual position of the tooling fixture 111 to calculate a function to correct the discrepancy between the apparent and actual positions, for example, using a linear regression. In some embodiments, the actual position of the tooling fixture 111 can be extracted mathematically based on measurements of the plurality of reference datum 113 accounting for a previously determined calibration of the respective downward facing camera 105a.

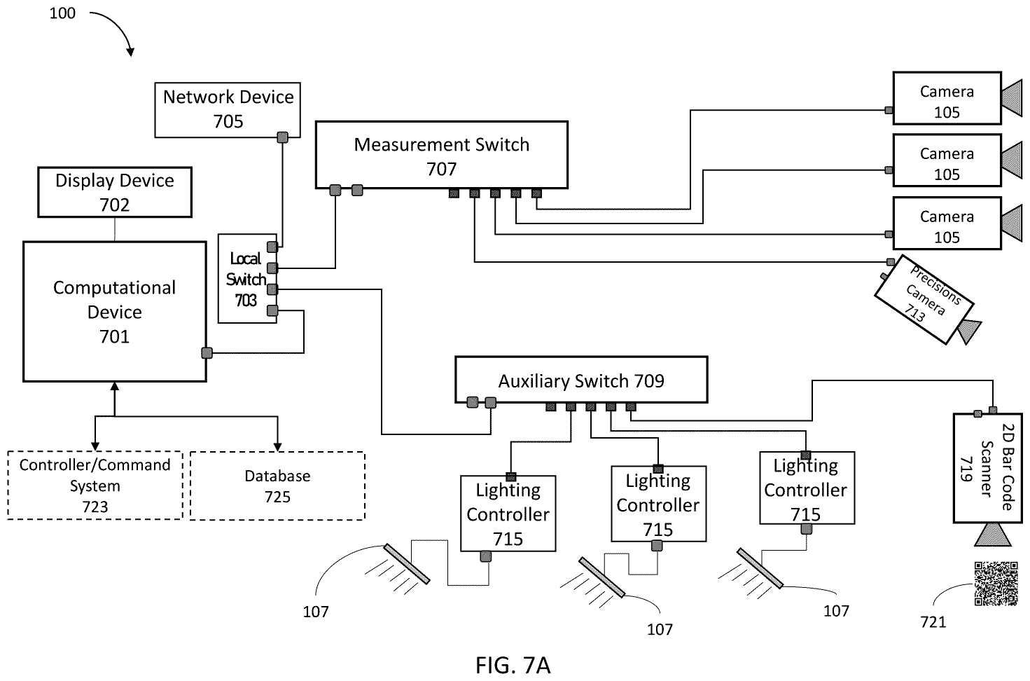

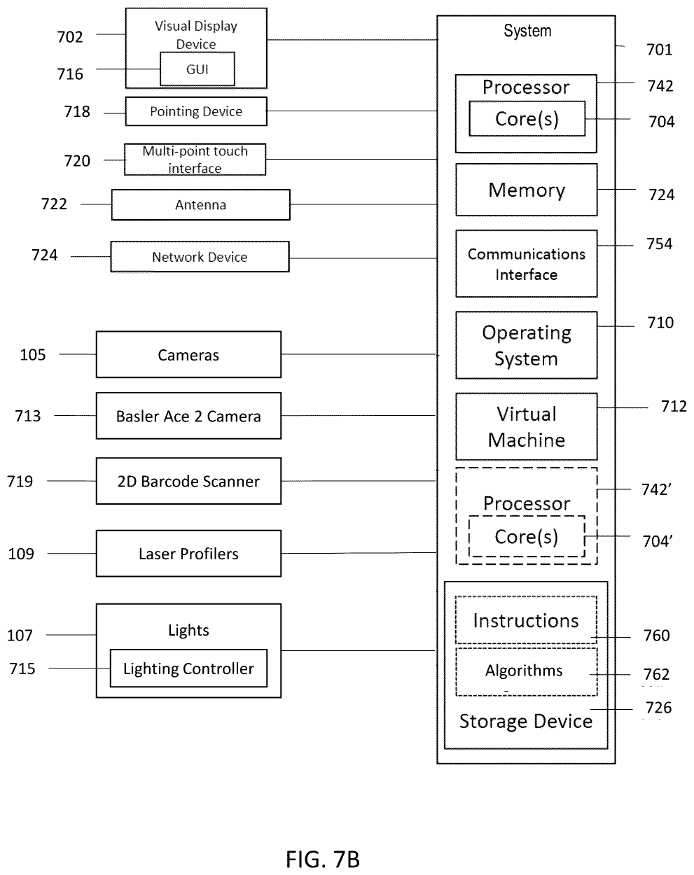

Referring now to FIG. 7A, shown is a schematic depiction of a tool monitoring system 100 according to some embodiments of the present disclosure. The tool monitoring system may include a computational device 701 connected to a display device 702. The computational device 701 may be connected to a local switch 703 which is connected to a network device 705 providing network access (such as to the internet or a local area network) to the computer 701. The local switch 703 may be connected to a measurement switch 707 and an auxiliary switch 709. The measurement switch 707 may be connected to a plurality of cameras 105 and a precision camera 713. The auxiliary switch 709 may be connected to a plurality of lighting controllers 715, each of the lighting controllers 715 may control a light 107. The auxiliary switch 709 may also be connected to a 2D scanner 719 used to read an identifier 721 associated with an object, e.g., a tooling fixture. The 2D scanner 719 may be a camera, QR code reader, barcode scanner or other device capable of reading the identifier 721. The connection between the components of the tool monitoring system 100 may be any data communication connection, including but not limited to, wired connections, wireless connections, or a combination thereof.

In some embodiments, the precision camera 713 can be a Basler Ace 2 camera or another camera capable of capturing images with a greater number of pixels-per-mm relative to the plurality of cameras 105. One or more of the plurality of cameras 105 can be replaced or supplemented by one or more precision cameras 713 where a higher degree of accuracy is needed.

In some embodiments, the computational device 701 may be connected to an external controller/command system 723 or database 725, such as a programmable logic control (PLC), a manufacturing execution system (MES), a scheduling assistant, and/or data logger, although not limited thereto.

The plurality of cameras 105 and the precision camera 713 may be used to measure/image the position of an object, e.g., a tooling fixture 111, and fixtures thereon and transmit the measurements and images to the computational device 701. The computational device 701 may control lights 107 via a respective lighting controller 715 to turn on/off and adjust the intensity of individual lights 107 to improve the accuracy/functionality of the cameras 105, 713. For example, the lights 107 may be turned on/off to prevent shadows or block ambient light which may interfere with the operation of the cameras 105, 713. The computational device 701 may use the transmitted measurements to calculate a frame of reference of the object and the relative position of a feature of interest on the object. These may in turn be used to calculate a function which corrects for differences between the actual and apparent position of the feature of interest. The actual position of the feature of interest being the position triangulated by the two of the plurality of cameras 105 and the apparent position of the feature of interest being the position in the frame of reference of the tooling fixture 111. The 2D scanner 719 may read an identifier 721 on the object and the computational device 701 may associate the measurements, images, and calculated function with the identifier 721 for storage on a database 725.

In some embodiments, the identifier 721 is a QR code and the 2D scanner 719 is a QR code scanner. In another embodiment, the identifier 721 is an alpha-numeric code and the 2D scanner 719 uses optical character recognition (OCR) to read the identifier 721.

In some embodiments, the computer 701 may compare the difference between the actual and apparent position of the feature of interest to a threshold tolerance. If the difference between the actual and apparent position of the feature of interest is greater than the threshold tolerance the computational device 701 may display a high level alert on the display device 702, automatically stop the tool monitoring system 100, and record the high level alert on the data base 725 associated with the identifier 721 of the object, e.g., the tooling fixture.

In some embodiments, different tolerance criteria can trigger an alert or action by the system depending on specific user requirements. For example, if a single feature of interest is out of tolerance a high level alert can be triggered or a high level alert is triggered when a certain number or percentage of features of interest are out of tolerance. Similarly, an automatic stoppage can be triggered when a single feature of feature of interest is out of tolerance or when a certain number or percentage of features of interest are out of tolerance. The trigger criteria for a high level alert and an automatic stoppage may be the same or different from each other.

Referring now to FIG. 7B, shown is the computational device 701 for use with some embodiments described herein. The computational device 701 may be, but is not limited to, a smartphone, laptop, tablet, desktop computer, server, or network appliance. The computational device 701 includes one or more non-transitory computer-readable media for storing one or more computer-executable instructions or software for implementing the various embodiments taught herein. The non-transitory computer-readable media may include, but are not limited to, one or more types of hardware memory (e.g., memory 744), non-transitory tangible media (for example, storage device 726, one or more magnetic storage disks, one or more optical disks, one or more flash drives, one or more solid state disks), and the like. For example, memory 744 included in the computational device 701 may store computer-readable and computer-executable instructions 760 or software (e.g., instructions to receive data from one or more of the plurality of cameras 105, data from precision camera 713, data from one or more of the plurality of laser profilers 109, and data from the 2D bar code scanner 719; instructions to control one or more of the plurality of lights 107 via a respective lighting control 715, execute algorithms 762, for calculating a frame of reference of the tooling fixture 111 and for calculating a function which predicts the apparent movement of a feature of interest; etc.) for implementing operations of the computational device 701. The computational device 701 also includes configurable or programmable or both processor(s) (e.g., processing device 742) and associated core(s) 704, and optionally, one or more additional configurable and/or programmable processor(s) 742′ and associated core(s) 704′ (for example, in the case of computer systems having multiple processors/cores), for executing computer-readable and computer-executable instructions or software stored in the memory 744 and other programs for implementing embodiments of the present disclosure. Processor 742 and processor(s) 742′ may each be a single core processor or multiple core (704 and 704′) processor. Either or both of processor 742 and processor(s) 742′ may be configured to execute one or more of the instructions described in connection computational device 701.

Virtualization may be employed in the computational device 701 so that infrastructure and resources in the computational device 701 may be shared dynamically. A virtual machine 712 may be provided to handle a process running on multiple processors so that the process appears to be using only one computing resource rather than multiple computing resources. Multiple virtual machines may also be used with one processor.

Memory 744 may include a computer system memory or random access memory, such as DRAM, SRAM, EDO RAM, and the like. Memory 744 may include other types of memory as well, or combinations thereof.

A user may interact with the computational device 701 through a display device 702 (e.g., a computer monitor, a projector, and/or the like including combinations and/or multiples thereof), which may display one or more graphical user interfaces 716. The user may interact with the computational device 701 using a multi-point touch interface 720 or a pointing device 718.

The computational device 701 may also include one or more computer storage devices 726, such as a hard-drive, CD-ROM, or other computer readable media, for storing data and computer-readable instructions 760 and/or software that implement exemplary embodiments of the present disclosure (e.g., applications). For example, exemplary storage device 726 can include instructions 760 or software routines to enable data exchange with one or more of the plurality of cameras 105, the precision camera 713, the plurality of laser profilers 109, the 2D bar code scanner. The storage device 726 can also include algorithms 762 that can be applied to imaging data and/or other data to calculate a frame of reference of the tooling fixture 111 and to calculate a function which predicts the apparent movement of a feature of interest.

The computational device 701 can include a communications interface 754 configured to interface via one or more network devices 705 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computational device 701 can include one or more antennas 722 to facilitate wireless communication (e.g., via the network interface) between the computational device 701 and a network and/or between the computational device 701 and components of the system such as the plurality of cameras 105, the precision camera 713, the plurality of laser profilers 109, the 2D bar code scanner, and the plurality of lights 107. The communications interface 754 may include a built-in network adapter, network interface card, PCMCIA network card, card bus network adapter, wireless network adapter, USB network adapter, modem or any other device suitable for interfacing the computational device 701 to any type of network capable of communication and performing the operations described herein.

The computational device 701 may run an operating system 710, such as versions of the Microsoft® Windows® operating systems, different releases of the Unix® and Linux® operating systems, versions of the MacOS® for Macintosh computers, embedded operating systems, real-time operating systems, open source operating systems, proprietary operating systems, or other operating system capable of running on the computational device 701 and performing the operations described herein. In exemplary embodiments, the operating system 710 may be run in native mode or emulated mode. In an exemplary embodiment, the operating system 710 may be run on one or more cloud machine instances.

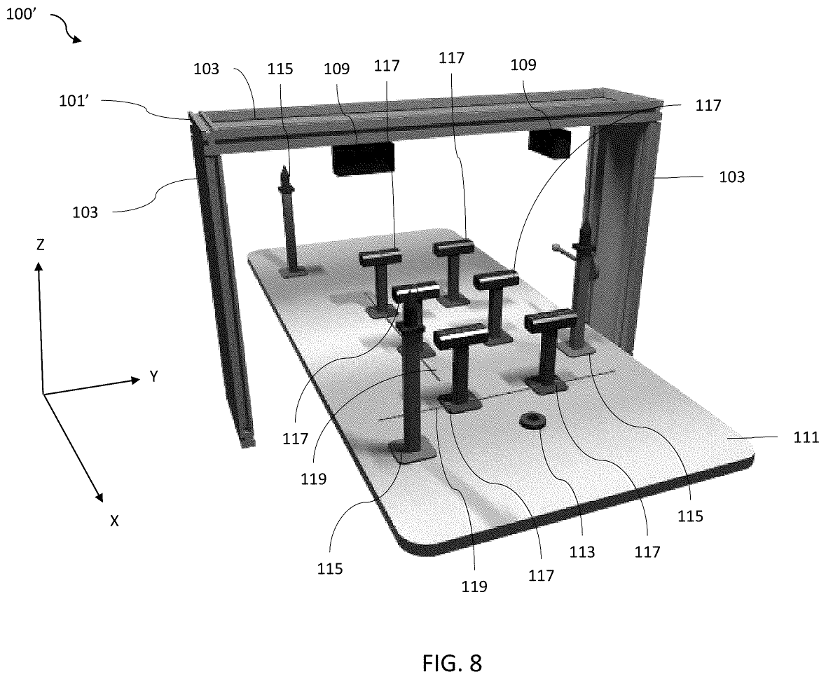

Referring now to FIG. 8, shown is a tool monitoring system 100′ according to some embodiments of the present disclosure. The tool monitoring system 100′ may include a housing 101′ made up of a plurality of panels 103. The housing 101′ may have two laser profilers 109 mounted on an interior wall, the two the laser profilers 109 projecting a laser line 119 onto the tooling fixture 111 in the X and Y direction. The tooling fixture 111, having a plurality of reference datum 113, a plurality of location pins 115, and a plurality of pads 117 arranged thereon, can pass under the housing 101′, the laser profilers 109, and the projected laser lines 119 to detect if the tooling fixture 111 is correctly configured with the appropriate fixtures and to detect whether there is any damage to the tooling fixture 111 or the fixtures. The housing 101′ may cover only a portion of the tooling fixture 111 whereby the tooling fixture 111 moves the entire length (or width) of the tooling fixture 111 under the housing 101′, so that the laser profilers 109 can sequentially inspect the entire length (or width) of the tooling fixture 111. In some embodiments, the housing 101′ and the laser profilers 109 may move the entire length (or width) of the tooling fixture 111 which the tooling fixture 111 remains stationary.

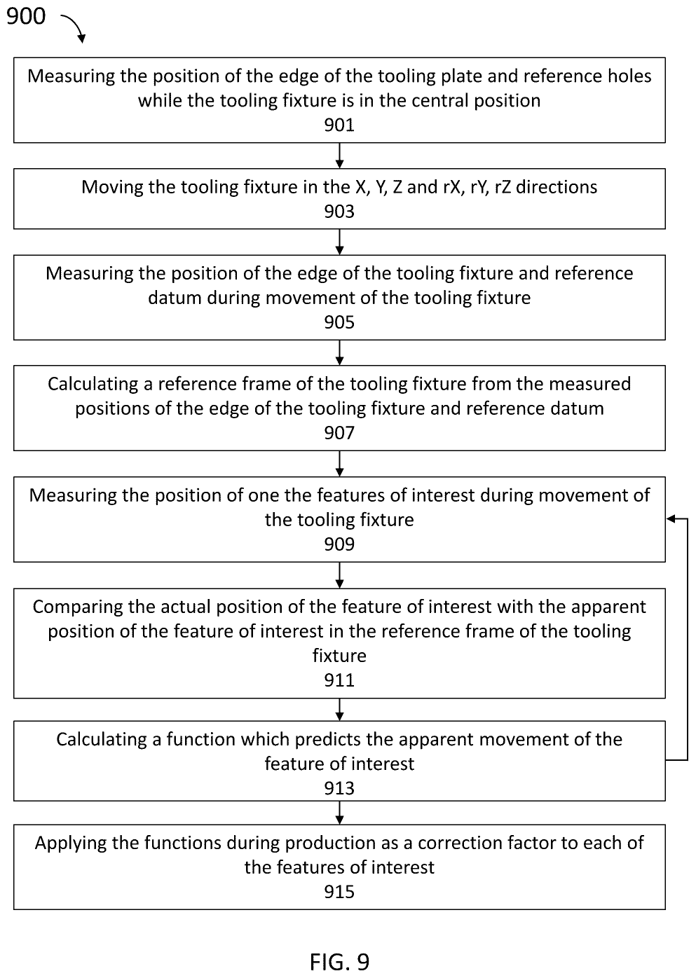

Referring now to FIG. 9, shown is a method 900 for calibrating a tooling fixture 111 for production. In some embodiments, the tooling fixture 111 is calibrated for production. A set of optical measurements is acquired in the nominal, central position, of the tooling fixture 111, step 901. The tooling fixture 111 is then moved over a range of positions in six degrees of freedom, X, Y, Z and rX, rY, rZ, step 903. The position of the center 301 of each of the plurality of reference datum 113 and the edge 403 of the tooling fixture 111 is measured as the tooling fixture 111 moves in each of the six degrees of freedom, step 905. The tool monitoring system is calibrated using the position of the center 301 of each of the plurality of reference datum 113 and at least three positions of the edge 403 of the tooling fixture 111 around at least two sides 401 of the tooling fixture 111 to establish the frame of reference during the series of measurements of the tooling fixture 111, step 907. Once the frame of reference of the tooling fixture 111 is established, the position of one of the plurality of location pins 115, the feature of interest, is triangulated using at least two of the plurality of cameras 105, step 909. The actual position of each of the plurality of location pins 115, the feature of interest, is compared to the apparent position of said location pin 115 relative to the calculated frame of reference of the tooling fixture 111, step 911. With an ideal calibration it would be expected that comparison of the position of one location pin 115, would be the same (i.e., no apparent movement) with respect to the frame of reference of the tooling fixture 111. However, there may be a difference between the actual and apparent position of the feature of interest. Using these differences in position in the X, Y, Z and rX, rY, rZ direction, a function which predicts the apparent movement of the one location pin 115, is calculated, step 913. In some embodiments, step 913 is carried out using a linear regression methodology for each of the coordinates of each of the features of interest, over each of the degrees of freedom. In some embodiments, steps 909, 911, and 913 can then be repeated for each of the plurality of location pins 115, with each of the plurality of location pins 115, i.e., features of interest, being configurable as to whether the position of the specific location pin 115 is required to be measured and compared to the frame of reference of the tooling fixture 111. In some embodiments, steps 909, 911, and 913 may be carried out simultaneously for each of the plurality of location pins 115. Each of the functions predicting the apparent movement of the respective location pin 115 can then be applied as a correction factor to respective feature of interest, e.g., the location pin 115, to reduce manufacturing error, step 915.

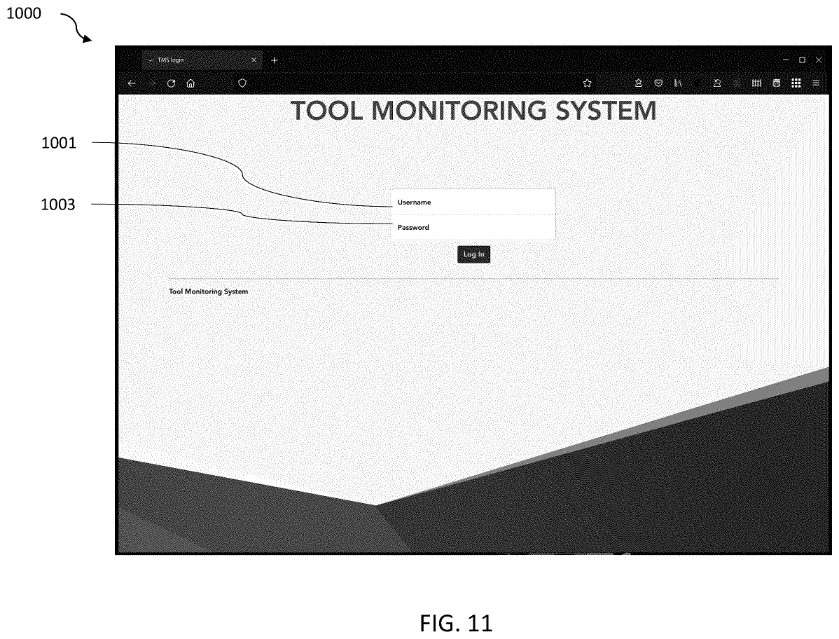

Referring now to FIGS. 11-14, shown are exemplary graphical user interfaces (GUIs) for a software application for the use and management of the tool monitoring system according to some embodiments of the present disclosure. The software application may be executed on computer 701 or another computing device which has a display and is cable of establishing a wired or wireless network connection. FIG. 11, illustrates a log in interface 1000 which may provide access to the configuration, production, and diagnostic information for past and current jobs. A user may fill out the username 1001 and password 1003 fields associated with a user profile in order to gain configuration access to tool monitoring systems 100, 800 and access historic diagnostic information from past and current jobs associated with the user profile.

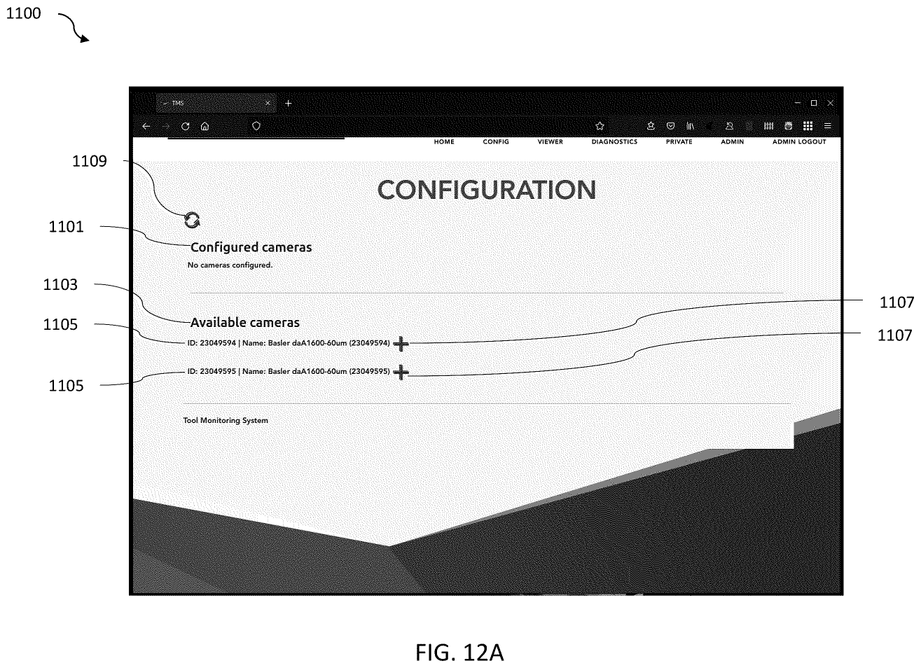

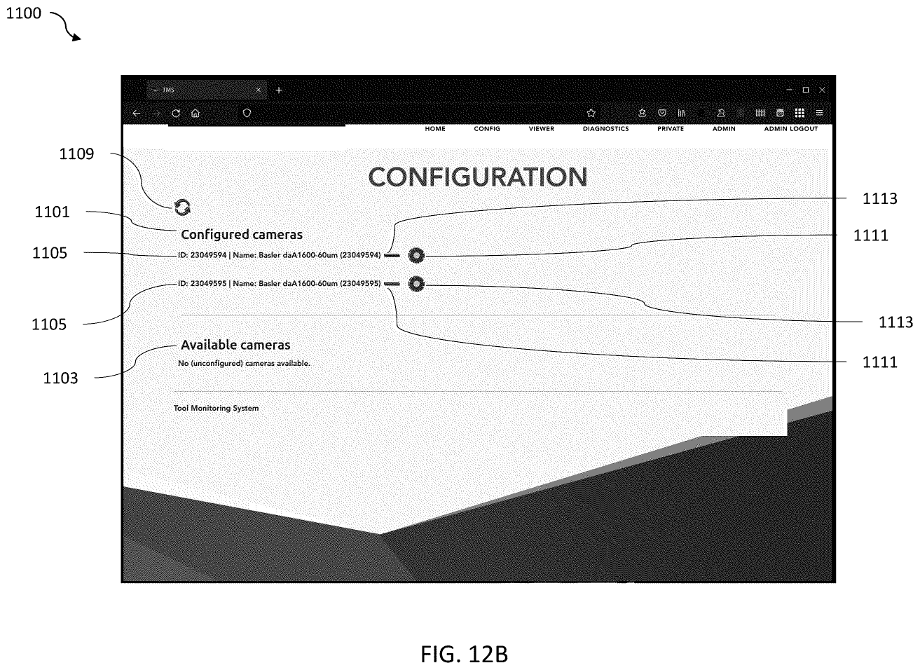

FIGS. 12A-12B illustrate a configuration interface 1100 displaying the configured cameras 1101 and the available cameras 1103 associated with the user profile, which are available and configurable to the user. The connected cameras 1105 are displayed either as configured cameras 1101 (shown in FIG. 12B), i.e., cameras which are setup and configured for use in a tool monitoring system, or as an available camera 1103 (shown in FIG. 12A), i.e., cameras which are connected to the network and are configurable but not yet configured for use. As illustrated in FIG. 12A, the connected cameras 1105 are available cameras 1103 and may have a + symbol 1107 indicating they are available to be configured for use. A user may select the + symbol 1107 of one of the connected cameras 1105 which may open a configuration screen promoting the user to configure the connected camera 1105 for use in a tool monitoring system, after which the connected camera 1105 will be a configured camera 1101. In some embodiments, the configurable settings of the connected camera 1105 may include, calibration of the camera, communication/connectivity details, the absolute or relative position, orientation, and angle of the camera, the zoom, the shutter speed, the camera mode (e.g., camera, metering, or drive mode if applicable depending of the camera model), color or black and white images, or automatic noise reduction, although not limited thereto. The configuration interface 1100 may also include a refresh button 1109 which may be used to update the list of configured cameras 1101 and available cameras 1103. As illustrated in FIG. 11B, the connected cameras 1105 are configured cameras 1101 and may have a − symbol 1111 indicating the connected camera 1105 may be removed from the configured camera 1101 list and a gear symbol 1113 indicating the settings of the connected camera 1105 may be checked and/or modified.

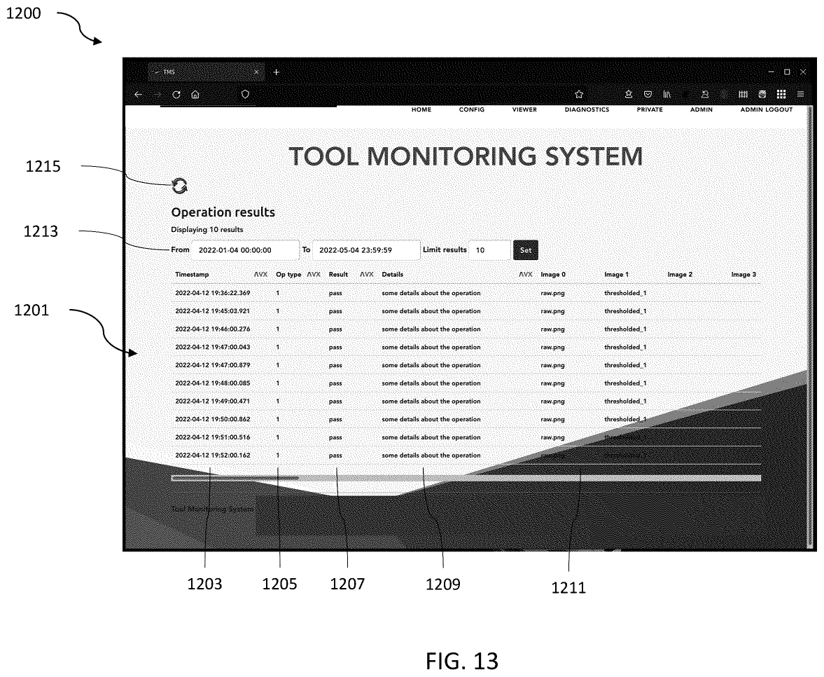

FIG. 13 illustrates a results interface 1200 displaying a selection of past and current job information. The results interface 1200 can display a set of jobs 1201 which can then be viewed and any issues addressed. The jobs 1201 may include identifiers such as the timestamp 1203 of when the job was carried out, the operation type 1205, the inspection results 1207, notes or details 1209 about the job, and the images 1211 captured by the cameras, e.g., configured cameras 1101. The results interface 1200 may also display whether a high level alert or a low level alert was triggered by the tool monitoring system. The jobs 1201 may be a particular measurement task carried out by a camera or set of cameras inspecting a feature of or fixture on the tooling fixture or may be the configuration carried out by the tool monitoring system including the measurements/images taken by all the cameras of the tool monitoring system. The results interface 1200 may use filter criteria 1213 to filter/limit the displayed results. The filter criteria 1213 may include filtering by timestamp 1203, number of results, job operation type 1205, a particular camera, tool monitoring system, or tooling fixture, and/or the inspection results 1207, although not limited thereto. The results interface 1200 may also include a refresh button 1215 which may be used to update the displayed set of jobs 1201 based on updated filter criteria 1213 or new job results.

In some embodiments the jobs 1201 may be associated with a code of a particular tooling fixture, for example identifier 721, and the displayed jobs 1201 may be filtered/searched based on the tooling fixture code.

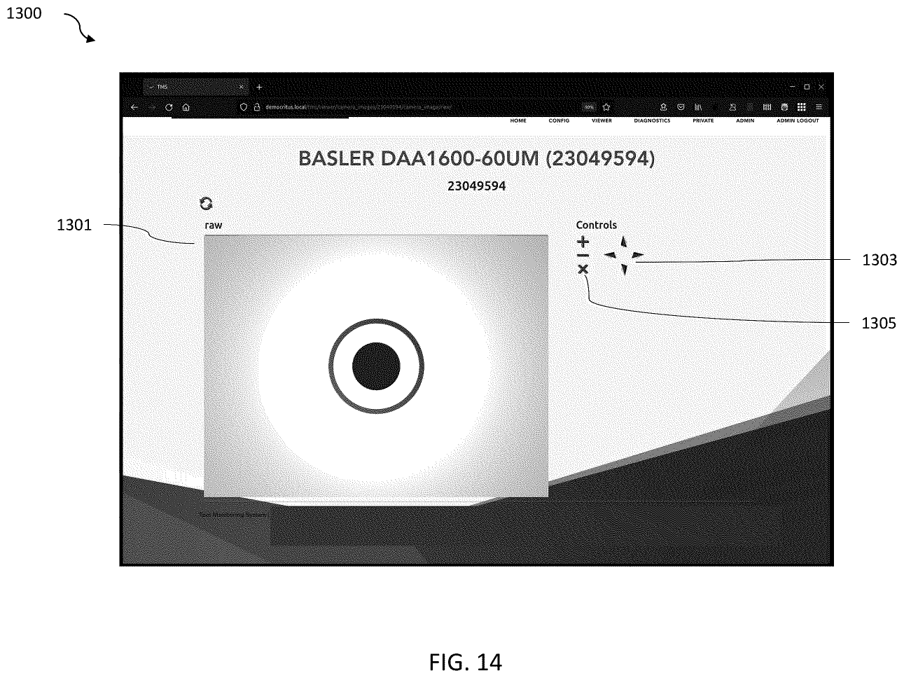

FIG. 14 illustrates a viewer interface 1300 which may display camera images and diagnostic images from the jobs 1201. The viewer interface 1300 may include a display 1301 of the stored image for inspection and full pan controls 1303 and zoom controls 1305 for the stored image. A user can manually inspect any of the images from the jobs 1201 to check that errors were correctly identified.

In some embodiments, the one or more graphical user interfaces 716 may be the log in interface 1000, the configuration interface 1100, the results interface 1200, and the viewer interface 1300.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments described herein.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A tool monitoring system comprising:
a housing, the housing sized and dimensioned to accommodate a tooling fixture in an interior portion thereof, the housing having a plurality of walls and at least one end that is open or openable for ingress and egress of the tooling fixture;
a plurality of cameras disposed on interior portions of the plurality of walls of the housing, at least three of the plurality of cameras are positioned on the interior portions of the plurality of walls to image a position of an edge portion of at least two sides of the tooling fixture, at least one of the plurality of cameras is positioned on the interior portions of the plurality of walls to image a position of each of a plurality of reference datum on the tooling fixture, and at least two of the plurality of cameras are positioned on the interior portions of the plurality of walls to image a position of each of a plurality of features of interest on the tooling fixture; and
a computational device having a memory and a processor configured to or programed to execute instructions held in memory to process image data received from each of the plurality of cameras to determine a relative location of one or more of the features of interest on the tooling fixture relative to a base of the tooling fixture, the processor calculating a frame of reference of the tooling fixture based on the position of the edge portions of the at least two sides of the tooling fixture and the position of each of the plurality of reference datum when the tooling fixture is in a first position relative to the housing and as the tooling fixture moves in at least one direction relative to the housing, and the processor calculates one or more correction functions which correct for differences between the position of at least a first of the features of interest and an apparent position of the first of the features of interest in the frame of reference.

2. The tool monitoring system of claim 1, further comprises a plurality of laser profilers disposed on interior portions of the plurality of wall of the housing and in electrical communication with the computational device;
wherein each of the laser profilers detects a sequence of the plurality of reference datum and the plurality of features of interest as the tooling fixture moves in at the at least one direction and transmits the sequence to the computational device;
wherein the computational device checks the sequence against an expected sequence of the plurality of reference datum and the plurality of features of interest.

3. The tool monitoring system of claim 1, wherein the plurality of cameras includes one or more redundant cameras in electrical communication with the computational device.

4. The tool monitoring system of claim 1, wherein the tooling fixture moves in the X, Y, Z, rX, rY, and, rZ directions.

5. The tool monitoring system of claim 1, wherein at least one of the plurality of walls is coupled to an adjacent wall by a hinge and is movable between a closed position and an open position.

6. The tool monitoring system of claim 1, wherein the plurality of reference datum are one or more reference holes and the plurality of features of interest are one or more tooling pins or one more tooling pads or a combination thereof.

7. The tool monitoring system of claim 1, further comprising a plurality of lights disposed inside of the housing, each of the plurality of lights in electrical communication with a controller in electrical communication with the computational device; the computational device configured to or programmable to adjust the intensity of one or more of the plurality of lights.

8. The tool monitoring system of claim 7, wherein at least one of the plurality of lights is positioned behind each of the features of interest in a field of view of at least two of the plurality of cameras imaging the position of said feature of interest.

9. The tool monitoring system of claim 1, wherein the tooling fixture is associated with a code affixed thereon and one of the plurality of cameras reads the code.

10. The tool monitoring system of claim 9, wherein the position of the edge portion of the at least two sides of the tooling fixture, the position of each of the plurality of reference datum, the position of each of the features of interest, the frame of reference of the tooling fixture, and the correction functions are associated with the code.

11. The tool monitoring system of claim 10, wherein the computational device is in electrical communication with a database;
wherein the computational device stores the code and the associated position of the edge portion of the at least two sides of the tooling fixture, position of each of the plurality of reference datum, position of each of the features of interest, frame of reference of the tooling fixture, and correction functions in the database.

12. The tool monitoring system of claim 11, further comprising executable instructions held in the memory for filtering and displaying the code and the associated position of the edge portion of the at least two sides of the tooling fixture, the position of each of the plurality of reference datum, the position of each of the features of interest, the frame of reference of the tooling fixture, and the correction functions stored in the database.

13. The tool monitoring system of claim 9, further comprising a threshold tolerance for differences between the position of at least a first of the features of interest and an apparent position of the first of the features of interest in the frame of reference;
wherein when the differences between the position of the first of the plurality of features of interest and the apparent position of the first of the plurality of features on interest in the frame of reference are greater than the threshold tolerance an alert that the tooling fixture is out of tolerance is associated with the code.

14. The tool monitoring system of claim 1, further comprising executable instructions held in the memory for configuring one or more cameras of the plurality of cameras.

15. A method of operation for a tool monitoring system, the method comprising:
imaging a position of an edge portion of a tooling fixture and a position of one or more reference datum disposed on or in the tooling fixture while the tooling fixture is in a central position;
moving the tooling fixture in at least one direction;
imaging the position of the edge portions of the tooling fixture and the position of the one or more reference datum as the tooling fixture moves;
calculating a frame of reference of the tooling fixture from the positions of the edge portions of the tooling fixture and the one or more reference datum;
imaging a position of a feature of interest disposed on the tooling fixture as the tooling fixture moves;
comparing the position of the feature of interest to an apparent position of the feature of interest in the frame of reference to determine an offset of the feature of interest; and
calculating one or more correction functions which correct for the offset of the feature of interest.

16. The method of operation for a tool monitoring system of claim 15, further comprising applying the one or more correction functions during production as a correction factor to each of the features of interest.

17. The method of operation for a tool monitoring system of claim 15, further comprising comparing the offset of the feature of interest to a threshold tolerance; and
transmitting a pass result if the offset is below the threshold tolerance or an alert if the offset is above the threshold tolerance to a database.

18. The method of operation for a tool monitoring system of claim 15, wherein the tooling fixture moves in the X, Y, Z, rX, rY, and, rZ directions.

19. The method of operation for a tool monitoring system of claim 15, wherein the one or more correction functions are calculated using a linear regression.
